(19) United States
(12) Patent Application Publication
(10) Pub. No.: US 2004/0158829 A1
(43) Pub. Date: Aug. 12, 2004

(54) Downloading application software to a mobile terminal

(76) Inventors: Evgenij Beresin, Helsinki (FI); Martin Zilliacus, Kauniainen (FI)

Correspondence Address: BANNER & WITCOFF, 1001 G STREET N W, SUITE 1100, WASHINGTON, DC, 20001, US

(21) Appl. No.: 10/471,570

(22) PCT Filed: Mar. 30, 2001
(86) PCT No.: PCT/IB01/00536

(51) Int. Cl. G06F 9/44

(52) U.S. Cl. 717/178; 717/173; 717/101

(57) ABSTRACT

A method and system are provided for providing a seamless link between a mobile terminal and application software stored on a server. An icon corresponding to the application software is displayed on a display of the mobile terminal. In response to a user selecting the icon, the mobile terminal downloads the application software from the server and automatically runs the application software. The mobile terminal may also be configured to remove one more applications from the mobile terminal to free up enough memory for the application software.

### BACKGROUND OF THE INVENTION

1. Field of the Invention

The present invention relates generally to the management of software installed on a mobile terminal. More particularly, the invention provides a method and system for storing software on a server and transmitting the software to a mobile terminal when the software is needed by the mobile terminal.

2. Description of Related Art

Consumers are increasingly using mobile terminals, such as cellular telephones and handheld computing devices. In addition to the traditional function of transmitting telephone calls, mobile terminals have been used for additional functions, such as accessing the Internet, storing scheduling information, storing telephone numbers and running a variety of software applications. Mobile terminals are integrating more and more capability typically associated with conventional computing devices. As a result of technical developments, the mobile terminal processing circuitry is generally capable of running, i.e., executing, content, also referred to as an application program.

Content, executable or otherwise usable by the processing circuitry, is typically stored at a memory device which is accessible by the processing circuitry. Content can be downloaded to a mobile terminal from the WWW, sometimes directly, and sometimes indirectly. If the mobile terminal has the capability to connect directly to the WWW, the application can be downloaded directly. In contrast, if an intermediate device such as a PC is used, the content is said to be downloaded to a mobile terminal indirectly. Downloading content to a Nokia 9000 Series ™ is possible, for example, by way of a cable or infrared connection from a source such as a personal computer. Increased amounts of, and types of, content shall likely become available for downloading to a mobile terminal in the future.

Because of the limited memory capacity of mobile terminals, when installing a new application, a user or the mobile terminal itself may have to eliminate an old application in memory to make room for a new application in memory. When the maximum capacity of the memory is reached on a mobile terminal, the operating system cannot normally provide memory management of the problem without user intervention. When downloading a new application, if the problem of memory limitation occurs, the user is typically prompted to free, in a manual way, memory before continuing. Alternatively, the user is required to add memory modules to the mobile terminal.

Therefore, there exists a need in the art for systems and methods that allow users of mobile terminals to utilize a large number of applications without increasing the physical memory requirements of the mobile terminals.

### SUMMARY OF THE INVENTION

It is an object to the present invention to provide a seamless link between a mobile terminal and application software stored on a server. It is a further object of the present invention to provide a mobile station that can run a large number of application programs without requiring an excessively large memory.

These and other objects are achieved in a method for downloading an application chosen by a user to a mobile terminal from an application storage. If the size of a memory currently available at the mobile terminal is not sufficient to store the chosen application, one or more applications are selected which occupy such memory in the mobile terminal having a size which, when aggregated with the size of the memory currently available, is sufficient to store the chosen application. The selected applications are then deleted from the mobile terminal memory in order to free space for the chosen application. Then the chosen application is downloaded from the application storage and stored in the aggregate of the memory currently available at the mobile terminal after deletion of the selected applications. In one embodiment of the invention, all of the steps, other than the step of receiving a request from the user, occur automatically, without intervention by the user.

In another embodiment of the invention, the objects recited above and other objects are achieved in a method of providing a seamless link between a mobile station and software stored in a server. The method includes the steps of: (1) providing an icon representing a software application on a display of the mobile terminal; (2) storing the software program in the server, and (3) in response to a user selecting the icon, transmitting the software application from the server to the mobile station and automatically running the software application.

In yet another embodiment of the invention, a computer-readable medium having computer-executable instructions is provided. The computer-executable instructions are for performing the steps of (1) providing an icon representing a software application on the display of the mobile terminal; (2) in response to a user selecting the icon, causing the mobile station to automatically retrieve the software application from a server; and (3) running the software application without a further command from the user.

In another embodiment of the invention, a system having a mobile terminal in communication with a server is provided. The system includes a mobile terminal display that includes an icon representing an application program. A server memory stores the application program. And, a mobile terminal processor includes computer executable instructions for performing the steps of: (1) in response to a user selecting the icon, causing the mobile station to automatically retrieve the software application from the server; and (2) running the software application without a further command from the user.

### BRIEF DESCRIPTION OF DRAWINGS

The invention will be described in detail in the following description of preferred embodiments with reference to the following figures wherein:

FIG. 1 is a schematic diagram of a mobile terminal and server in accordance with an embodiment of the invention;

FIG. 2 is a schematic diagram illustrating a graphical user interface in accordance with an embodiment of the invention;

FIG. 3 depicts an exemplary data structure; and

FIG. 4 is a flow chart of one embodiment of a method of operating the a communication system, together with the picture displayed at certain stages of the flow chart.

### DETAILED DESCRIPTION OF PREFERRED EMBODIMENTS

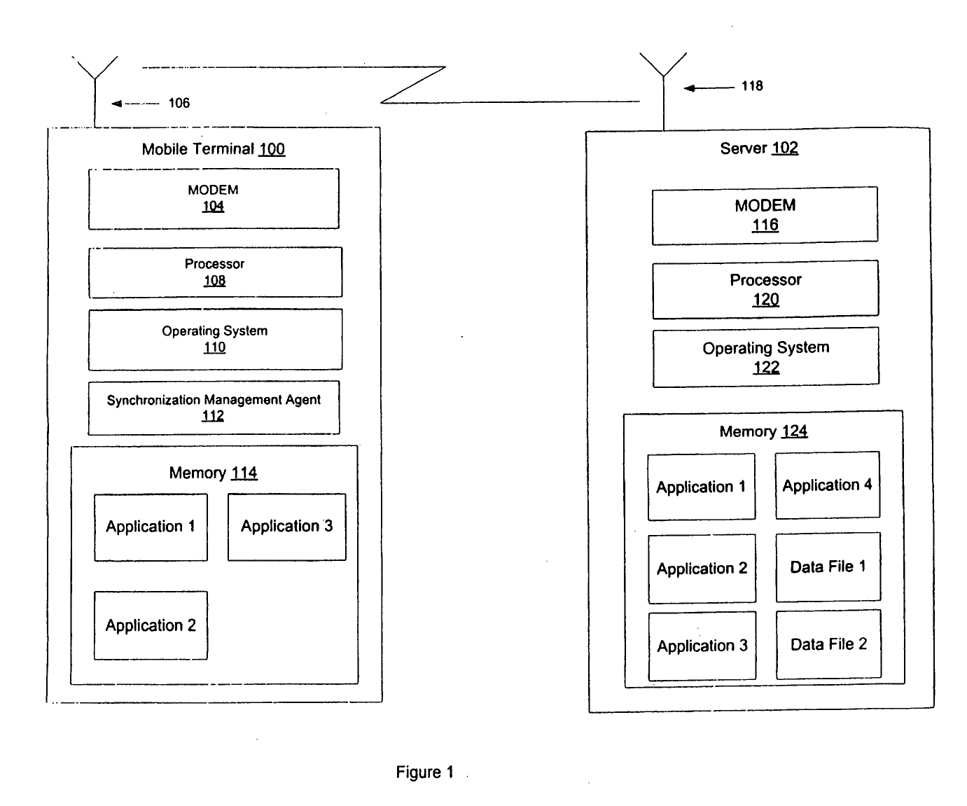

FIG. 1 illustrates a communication system that includes a mobile terminal 100 and a server 102. Mobile terminal 100 may be implemented with devices such as mobile telephones, personal digital assistants (PDAs) or other wireless devices. A modem unit 104 and an antenna 106 are used to transmit data in a conventional manner. Modem unit 104 may be a standard RF transceiver or any other type of modem. Mobile terminal 100 may be a Nokia 9110 Communicator, an Ericsson MC218 Communicator, a Nokia 9210 Communicator or any other type of wireless communication device.

A processor 108 may be connected to modem unit 100 and other components within mobile terminal 100. Processor 108 controls the overall operation of mobile terminal 100 and may receive instructions from an operating system 110 in a conventional manner. Examples of suitable operating systems that may be used with the present invention include PalmOS, Windows CE or EPOC. (EPOC is an operating system intended for handheld wireless communication devices. EPOC supports the Java programming language and Wireless Application Protocol (WAP) for wireless Internet communication. EPOC is available from Symbian.).

Mobile terminal 100 also includes a synchronization management agent 112. The synchronization management agent 112 interacts with a memory 114. Memory 114 may store a variety of software applications and data files. The operation of synchronization management agent 112 will be described in detail below.

Server 102 includes a modem 116 and an antenna 118 for communicating with mobile terminal 100. While FIG. 1 shows a wireless connection between mobile terminal 100 and server 102, a variety of well known hardware devices and associated software may be used for receiving and processing signals. For example, communication can be conducted via switched or non-switched paths using private or public facilities. With the wireless embodiment shown in FIG. 1, mobile terminal 100 and server 102 may communicate via wireless link, utilizing any of the wireless mobile networks (like GSM) and wireless communication protocols (like WAP). For example, the system can employ CSD (i.e., Circuit Switched Data), GPRS (i.e., General Packet Radio Service, the data service for GSM, the European standard digital cellular service) and EDGE (i.e., Enhanced Data for GSM Evolution, an additional stage in the evolution of data communications within the existing GSM standards). Although this specification refers to GSM (i.e., Global System for Communication) devices, it is not intended to be limited to GSM devices.

Server 102 also includes a processor 120 and an operating system 122 which work together in a conventional manner to control the overall operation of server 102. A variety of different operating systems 122 may be used with the present invention. Examples of suitable commercially available operating systems include: Sun's Solaris operating system, Hewlett-Packard's HP-UX operating system and Microsoft's Windows NT operating system. Server 102 also includes a memory 124 that can be used to store a variety of application programs, data files or other binary files. Server 102 may also include a variety of conventional components (not shown) typically found in servers configured to communicate with mobile terminals, such as Nokia WAP server application software.

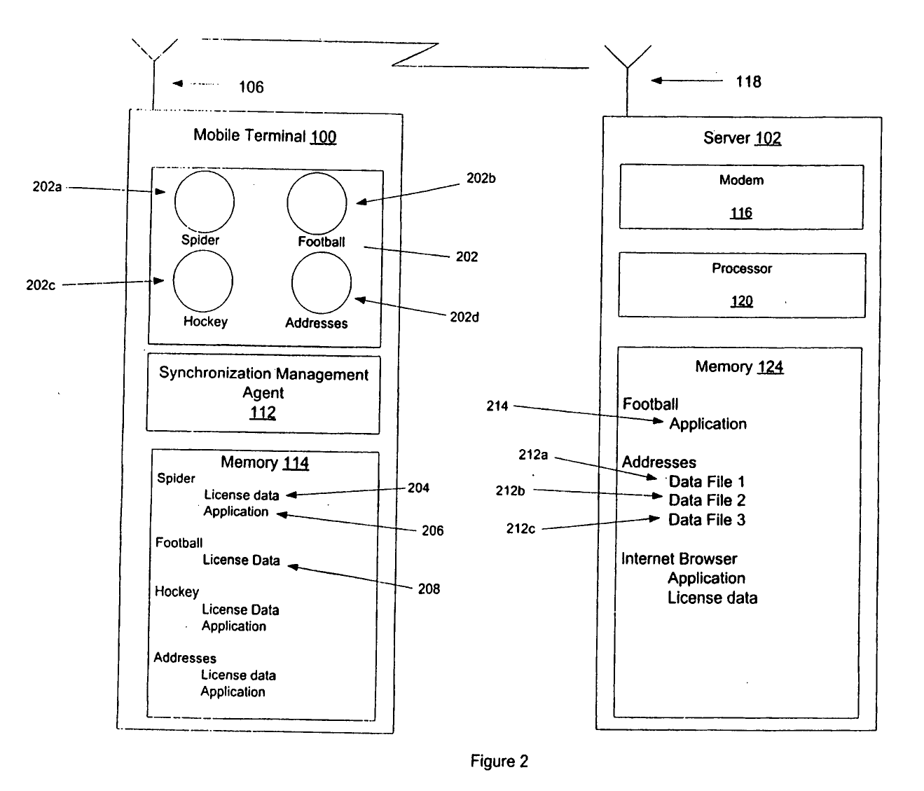

The operation of mobile terminal 100 and server 102 will now be described with reference to FIG. 2. Mobile terminal 100 includes a graphical user interface 202 that includes icons 202a-202d. A user may select icons 202a-202d in a variety of different ways. For example, mobile terminal 100 may include a touch sensitive screen that displays icons 202a-202d and allows the user to select an icon by pressing on the screen. Alternatively, the user may select an icon by utilizing an input device that allows the user to highlight one of the icons. The present invention does not require that mobile terminal 100 include a graphical user interface. In alternative embodiments, a simple listing of application programs may be presented to the user.

FIG. 2 shows that memory 114 includes data that corresponds to each one of the icons shown with graphical user interface 202. For example, memory 114 includes license data 204 and an application program 206 that corresponds to the Spider icon 202a.

One of the advantages of the present invention is that it does not require all of the software applications and data files that are required to execute a given program to be stored in mobile terminal 100. For example, memory 114 includes license data 208 for the football program. When the user selects football icon 202b, synchronization management agent 112 determines that the football application is not stored in memory 114 and interacts with server 102 in a manner that will be described in detail below to cause processor 120 to retrieve football application 214 from memory 124 and to transmit football application 214 to mobile terminal 100. Football application 210 will then be stored in memory 114. The configuration shown in FIG. 2 provides a seamless user interface that allows the user to run a variety of programs with mobile terminal 100 while not requiring that all of the necessary files be stored in memory 114. Memory 124 and server 102 function like a “virtual memory” for mobile terminal 100.

Before downloading a requested file from server 102, synchronization management agent 112 may determine that memory 114 does not include enough free memory for storing the requested file. Synchronization management agent 112 may then determine which file(s) stored in memory 114 of mobile terminal 100 can be deleted in order to free memory for the requested file. Synchronization management agent 112 may use a variety of different criteria for determining which files to delete. In one embodiment, synchronization management agent 112 selects file(s) that have been used least frequently by the user of mobile terminal 100. In an alternative embodiment, synchronization management agent 112 may select file(s) that together with existing unoccupied memory space constitute a continuous block of memory, in order to decrease fragmentation of memory 114. For example, before downloading football application 214, synchronization management agent 112 may delete spider application 206 in order to free enough space in memory 114. After deletion of the selected file(s) from memory 114 of mobile terminal 100, the synchronization management agent 112 sends to the server 102 a request to transmit the required file. Server 102 retrieves this file from its memory 124 and transmits it using modem unit 116. After mobile terminal 100 has received the required file, using modem unit 104, synchronization management agent stores it in memory 114.

Files that are deleted from mobile terminal 100 may be stored in server 102. For example, synchronization management agent 112 may retrieve a file that is stored in memory 114 of mobile terminal 100 and identified to be deleted and transmit the retrieved file to server 102. Server 102 may store the transmitted file in memory 124 before transmitting the requested file to mobile terminal 100.

In one embodiment of the invention, license data, such as spider license data 204 is always stored in memory 114. When requesting application or data files from server 102, server 102 can require that mobile terminal 100 transmit the relevant license data to ensure that the user is a licensed user of the appropriate software program.

In addition to storing software applications in memory 124, server 100 may also store data files in memory 124. For example, three separate data files 212a-212c are listed under the addresses program. Data file 212a may correspond to a user's personal addresses. Data file 212b may correspond to address information for employees assigned to a local office and data file 212c may correspond to address information for all of the employees assigned to a large company. The user of mobile terminal 100 may retrieve, in a seamless manner, only the data files that the user needs at a given time to minimize the size of memory 114 while still providing the user access to a large amount of data.

It will be apparent to one of skill in the art that if operating system 110 contains an implementation of the Java language virtual machine (JVM) then synchronization management agent 112 may be implemented as an application written in the Java language. Otherwise (if operating system 110 does not provide JVM) synchronization management agent 112 may be implemented as a component of the operating system 110.

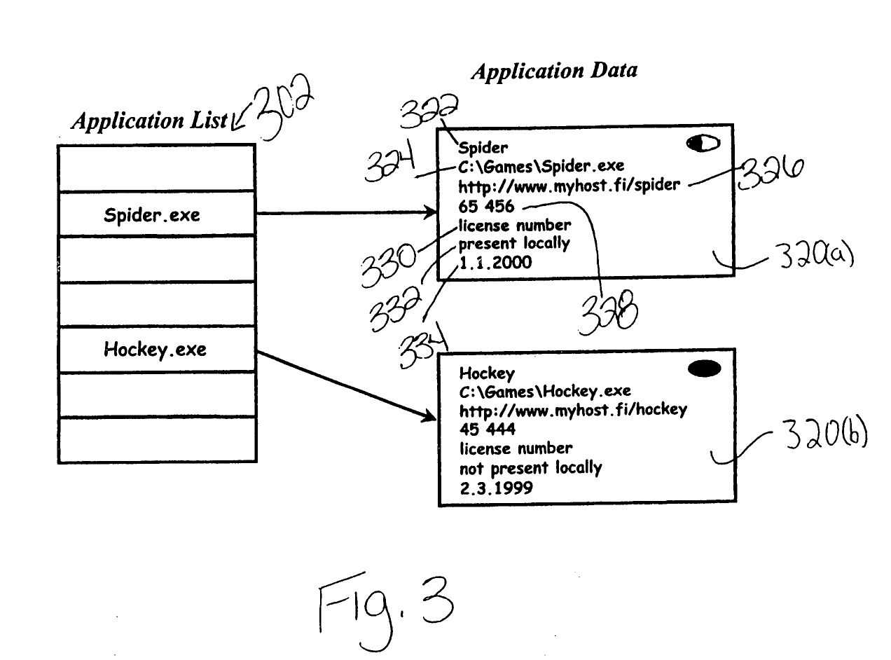

FIG. 3 illustrates one possible embodiment of data structure that facilitates the operation of synchronization management agent 112. An application list 302 points to the application data 320a and 320b. The information about an application in the application data 320a may include: application name 322, the location 324 of the application in the file system of the mobile terminal memory 114, the network location 326 of the application (URL in the case of the Internet), the application size 328 in bytes, a license number 330 if the application is subject to licensing, a flag 332 indicating the presence of the application code in mobile terminal's memory 114, and the date and time 334 of last accessing of the application.

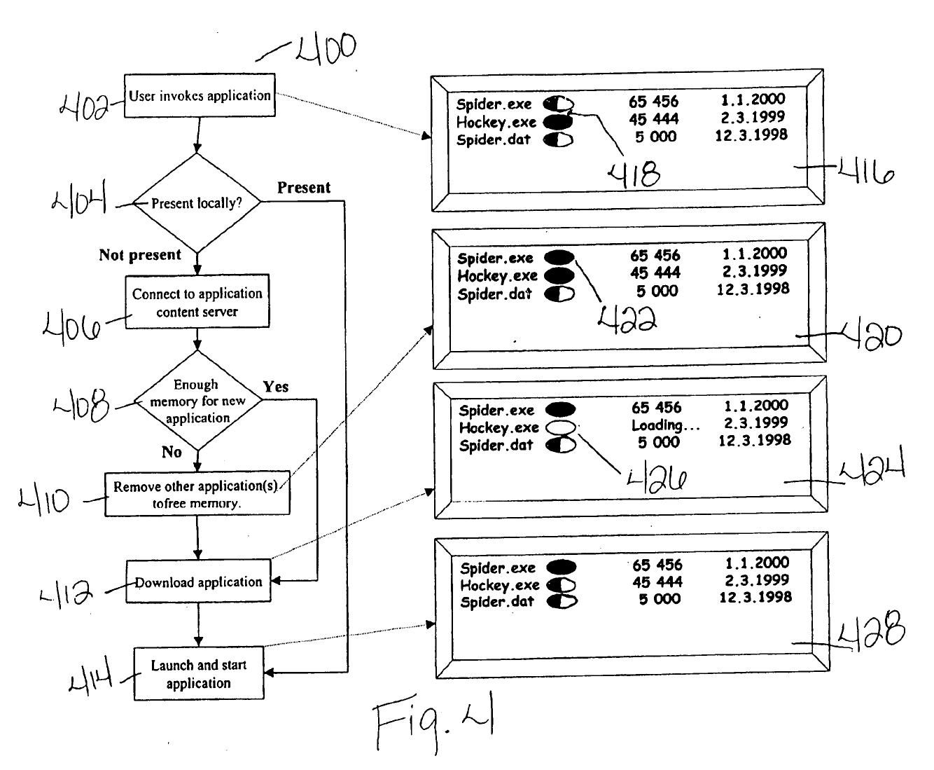

FIG. 4 depicts a flowchart 400 that illustrates the operation synchronization management agent 112 in accordance with one embodiment of the present invention. In step 402 the user of the remote terminal 110 invokes or chooses an application. For example, the user may select hockey icon 202c (shown in FIG. 2). In step 404, synchronization management agent 112 determines whether or not the selected application is currently stored in memory 114 of mobile terminal 100. If the application and any required files are stored locally, the application is launched and started in step 414. If the selected application is not stored in memory 114, synchronization management agent 112 causes mobile terminal 100 to connect to server 102 in step 406.

Next, in step 408, synchronization management agent 112 determines whether or not there is enough free memory in memory 114 to store the selected application. If there is sufficient free memory, the application is downloaded from server 102 in step 412. If there is insufficient free memory currently available, in step 410, synchronization management agent 112 selects one or more applications stored in memory 114 and which occupy memory of a size which, when aggregated with the size of the memory currently available at the remote terminal, is sufficient to store the chosen application. After freeing enough memory, the application is downloaded in step 412. Finally, the remote terminal can execute the chosen application in step 414.

In one embodiment, all those measures undertaken by the synchronization management agent other than receiving a request from the user occur automatically, without the user manually selecting and deleting files or taking other intervention steps.

Synchronization management agent 112 may also determine a movability metric for each application currently stored in the mobile terminal and select applications such that their movability metrics are larger than the movability metric of any of the applications not selected. The movability metric for an application in one embodiment will be the time interval since the last request by a user for the execution of that application. Of course, it will be apparent to one of skill in the art that other movability metrics can be devised and will be more valuable for certain purposes and contexts. In fact in one embodiment the user is allowed to devise a customized movability metric.

FIG. 4 also depicts a series of screen shots that may appear on mobile terminal 100 during several important stages of the set of operations shown in flow chart 400. A screen shot 416 includes a dark circle 418 next to “Hockey.exe” to indicate that the application for the hockey program is not stored in memory 114. A screen shot 420 includes a dark circle 422 next to “Spider.exe” to indicate that “Spider.exe” has been removed from memory 114. Next, a screen shot 424 includes a white circle 426 next to “Hockey.exe” to indicate that the application “Hockey.exe” is being downloaded to memory 114. Finally, screen shot 428 includes a dark circle to indicate that “Spider.exe” is no longer stored in memory 114 and a half dark circle to indicate that “Hockey.exe” is now stored in memory 114.

Having described preferred embodiments of the invention (which are intended to be illustrative and not limiting), it is noted that modifications and variations can be made by persons skilled in the art in light of the above teachings. It is therefore to be understood that changes may be made in the particular embodiments of the invention disclosed which are within the scope and spirit of the invention as defined by the appended claims.

Having thus described the invention with the details and particularity required by the patent laws, what is claimed and desired protected by Letters Patent is set forth in the appended claims.

1. A method for downloading an application chosen by a user to a mobile terminal from an application storage, the method comprising the steps of:
if the size of a memory currently available at the mobile terminal is not sufficient to store the chosen application, selecting one or more applications which occupy such memory at the mobile terminal having a size which, when aggregated with the size of the memory currently available, is sufficient to store the chosen application;
deleting the selected one or more applications from the mobile terminal memory;
transmitting to the application storage license data for the chosen application;
receiving the chosen application from the application storage; and
storing the received application into the aggregate of the memory currently available at the mobile terminal and the memory occupied by the selected one or more applications.

2. The method according to claim 1, further comprising the steps of:
if the size of the memory currently available at the mobile terminal is sufficient to store the chosen application, receiving the chosen application from the application storage; and
storing the application received into the memory currently available at the mobile terminal.

3. The method according to claim 2, wherein all the steps, other than the step of receiving a request from the user, occur automatically, without intervention by the user.

4. The method according to claim 3, further comprising the step of determining a movability metric for each application currently stored in the mobile terminal; and wherein each of the selected applications has a movability metric larger than the movability metric of any of the applications not selected.

5. The method according to claim 2, further comprising the step of determining a movability metric for each application currently stored in the mobile terminal; and wherein each of the selected applications has a movability metric larger than the movability metric of any of the applications not selected.

6. A method of providing a seamless link between a mobile station and a software application stored in a server, the method comprising the steps of:
(1) providing an icon representing a software application on a display of the mobile terminal;
(2) storing the software application in the server; and
(3) in response to a user selecting the icon, transmitting the software application from the server to the mobile station and automatically running the software application.

6a. The method of claim 6, wherein (3) further comprises transmitting to the server license data for the software application.

7. The method of claim 6, further including the steps of:
determining the size of the software application; and
deleting one or more software applications previously stored in the mobile terminal.

8. A computer-readable medium having computer-executable instructions for performing the steps of:
(1) providing an icon representing a software application terminal;
(2) in response to a user selecting the icon, causing the mobile station to automatically retrieve the software application from a server;
(3) deleting one or more software applications previously stored in the mobile terminal; and
(4) running the retrieved software application.

9. A system having a mobile terminal in communication with a server, the system comprising:
a mobile terminal display that includes an icon representing a software application;
a server memory that stores the software application;
a mobile terminal processor that includes computer executable instructions for performing the steps of:
(1) in response to a user selecting the icon, causing the mobile terminal to retrieve the software application from the server, and
(2) running the software application.

9a. The system of claim 9, wherein step (1) further includes causing the mobile terminal to transmit license data for the software application to the server.

10. A mobile terminal comprising:
a graphical user interface that includes an icon representing a first software application;
a memory that stores a second software application and license data for the first software application; and
a mobile terminal processor that includes computer execut the mobile terminal to perform the steps of:
(1) in response to a user selecting the icon, transmitting the license data for the first software application to a server, deleting the second software application and causing the mobile terminal to retrieve the first software application from the server; and
(2) running the first software application.
